(19) United States
(12) Patent Application Publication
(10) Pub. No.: US 2026/0253798 A1
(43) Pub. Date: Aug. 27, 2026

(54) MULTILAYER ELECTRONIC COMPONENT

(71) Applicant: SAMSUNG ELECTRO-MECHANICS CO., LTD., Suwon-si (KR)

(72) Inventor: Seung Ryeol LEE, Suwon-si (KR)

(73) Assignee: SAMSUNG ELECTRO-MECHANICS CO., LTD., Suwon-si (KR)

(21) Appl. No.: 19/437,626

(22) Filed: Dec. 31, 2025

(30) Foreign Application Priority Data
Feb. 24, 2025 (KR) 10-2025-0023407

(51) Int. Cl. H01G 4/12; H01G 4/005; H01G 4/232; H01G 4/30

(52) U.S. Cl. CPC H01G 4/12; H01G 4/005; H01G 4/30; H01G 4/232

(57) ABSTRACT

A multilayer electronic component includes: a body including a dielectric layer and an internal electrode; and an external electrode disposed on the body, wherein the dielectric layer includes a plurality of first protrusions having a hemispherical shape protruding only from one of the first and second surfaces and include a first opening portion, and at least a portion of the plurality of first protrusions are spaced apart from each other in a second direction perpendicular to the first direction, and when the radius of the first opening portion is R1 and the distance between the adjacent first protrusions in the second direction is G1, R1 and G1 may satisfy 0.3 μm≤R1≤3.0 μm and 0.5×R1≤G1≤3.0×R1.

### CROSS-REFERENCE TO RELATED APPLICATION(S)

This application claims benefit of priority to Korean Patent Application No. 10-2025-0023407 filed on Feb. 24, 2025 in the Korean Intellectual Property Office, the disclosure of which is incorporated herein by reference in its entirety.

### TECHNICAL FIELD

The present disclosure relates to a multilayer electronic component.

### DESCRIPTION OF RELATED ART

A multilayer ceramic capacitor (MLCC), a multilayer electronic component, is a chip-type condenser, mounted on the printed circuit boards of various types of electronic products, such as image display devices including a liquid crystal display LCD and a plasma display panel PDP, computers, smartphones and mobile phones, and may be configured to charge electricity therein or discharge electricity therefrom.

Such multilayer ceramic capacitors may be used as a component in various electronic devices due to having a small size, ensuring high capacitance and being easily mounted. As various electronic devices, such as computers and mobile devices, or the like, become smaller and have higher output, the demand for miniaturization and high capacitance of multilayer ceramic capacitors is increasing.

As miniaturization and thinning of multilayer ceramic capacitors progress, in order to improve capacitance characteristics, methods are being applied such as manufacturing an area in which capacitance is formed to be wider, increasing the number of layers through thinning thereof, or devising a material or a material mixing method with a high dielectric constant.

However, there is a limit to increase a capacitance formation area or increase the number of layers to miniaturize components, and there may be a problem, in that it takes a long time to find a material or material combination with a high dielectric constant.

### DISCLOSURE

### Technical Problem

One of many problems to be solved by the present disclosure is to provide a multilayer electronic component having improved capacitance characteristics.

One of many problems to be solved by the present disclosure is to provide a multilayer electronic component having excellent reliability.

One of many problems to be solved by the present disclosure is to provide a multilayer electronic component having improved structural defects.

However, the many problems to be solved by the present disclosure are not limited to the above, and will be more easily understood in the process of describing specific embodiments of the present disclosure.

### Solution to Problem

### SUMMARY

A multilayer electronic component according to an embodiment of the present disclosure may include: a body including a dielectric layer and internal electrodes alternately disposed with the dielectric layer in a first direction, the body including first and second surfaces opposing each other in the first direction, third and fourth surfaces connected to the first and second surfaces and opposing each other in a second direction, and fifth and sixth surfaces connected to the first to fourth surfaces and opposing each other in a third direction; and an external electrode disposed on the body, wherein the dielectric layer includes a plurality of first protrusions having a hemispherical shape protruding only from either the first surface or the second surface, where at least a portion of the plurality of first protrusions are spaced apart from each other in the second direction, and a first opening portion, and when a radius of the first opening portion is R1 and a distance between adjacent first protrusions among the plurality of first protrusions in the second direction is G1, R1 and G1 may satisfy 0.3 μm≤R1≤3.0 μm and 0.5×R1≤G1≤3.0×R1.

A multilayer electronic component according to another embodiment of the present disclosure, may include: a body including a dielectric layer and internal electrodes alternately disposed with the dielectric layer in a first direction, the body including first and second surfaces opposing each other in the first direction, third and fourth surfaces connected to the first and second surfaces and opposing each other in a second direction, and fifth and sixth surfaces connected to the first to fourth surfaces and opposing each other in a third direction; and an external electrode disposed on the body, and the internal electrodes may include a plurality of second protrusions having a hemispherical shape protruding only from either the first surface or the second surface, where at least a portion of the plurality of second protrusions are spaced apart from each other in the second direction, and a second opening portion, and when a radius of the second opening portion is R2 and, in the second direction, a distance between adjacent second protrusions among the plurality of second protrusions is G3, R2 and G3 may satisfy 0.3 μm≤R2≤3.0 μm and 0.5×R2≤G3≤3.0×R2.

### Advantageous Effects

One of many effects of the present disclosure is to improve a capacitance characteristics of multilayer electronic components.

One of many effects of the present disclosure is to improve reliability of multilayer electronic components.

One of many effects of the present disclosure is to improve structural defects that may occur during manufacture of multilayer electronic components.

However, the various advantageous effects of the present disclosure are not limited to the above, and will be more easily understood in the process of explaining specific embodiments of the present disclosure.

### BRIEF DESCRIPTION OF DRAWINGS

FIG. 1 schematically illustrates a perspective view of a multilayer electronic component according to an embodiment of the present disclosure.

FIG. 2 schematically illustrates a cross-sectional view taken along line I-I′ of FIG. 1.

FIG. 3 schematically illustrates a cross-sectional view taken along line II-II′ of FIG. 1.

FIG. 4 schematically illustrates a cross-sectional view taken along line III-III′ of FIG. 1.

FIG. 5 schematically illustrates a plan view of a dielectric layer.

### DESCRIPTION OF REFERENCE CHARACTERS

Hereinafter, embodiments of the present disclosure will be described with reference to specific embodiments and the accompanying drawings. However, embodiments of the present disclosure may be modified to have various other forms, and the scope of the present disclosure is not limited to the embodiments described below. Further, embodiments of the present disclosure may be provided for a more complete description of the present disclosure to the ordinary artisan. Therefore, shapes and sizes of the elements in the drawings may be exaggerated for clarity of description, and the elements denoted by the same reference numerals in the drawings may be the same elements.

In the drawings, portions not related to the description will be omitted for clarification of the present disclosure, and a thickness may be enlarged to clearly illustrate layers and regions. The same reference numerals will be used to designate the same components with the same reference numerals. Further, throughout the specification, when an element is referred to as “comprising” or “including” an element, it means that the element may further include other elements as well, without departing from the other elements, unless specifically stated otherwise.

In the drawings, a Z-direction may be defined as a thickness direction or a first direction, an X-direction as a length direction or a second direction, and a Y-direction as a width direction or a third direction. Additionally, a stacking direction may be a thickness direction or a width direction.

In addition, in the present disclosure, a thickness may refer to a size in the first direction, a length may refer to a size in the second direction, and a width may refer to a size in the third direction.

### Multilayer Electronic Component

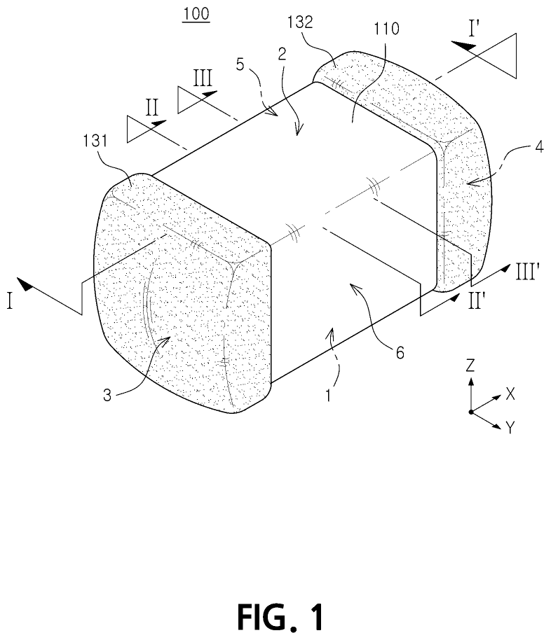

FIG. 1 schematically illustrates a perspective view of a multilayer electronic component according to an embodiment of the present disclosure.

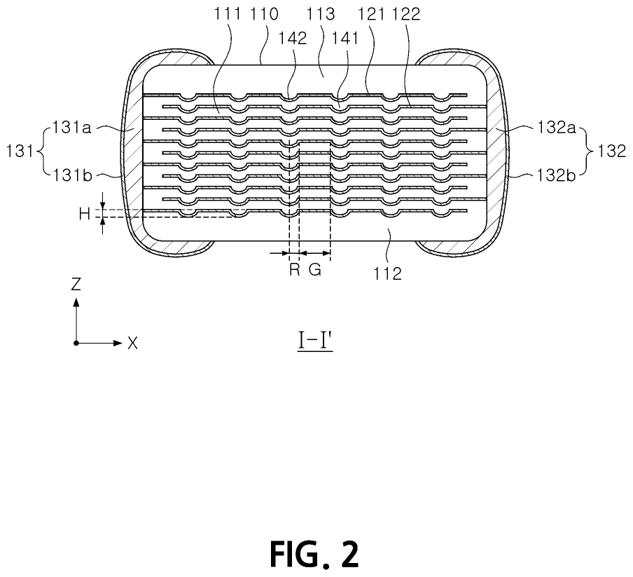

FIG. 2 schematically illustrates a cross-sectional view taken along line I-I′ of FIG. 1.

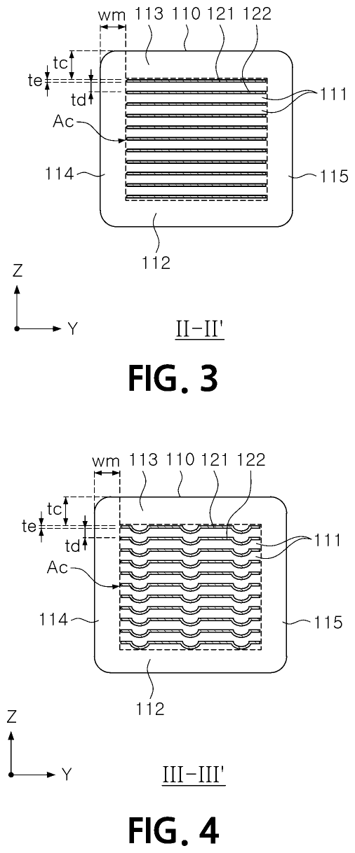

FIG. 3 schematically illustrates a cross-sectional view taken along line II-II′ of FIG. 1.

FIG. 4 schematically illustrates a cross-sectional view taken along line III-III′ of FIG. 1.

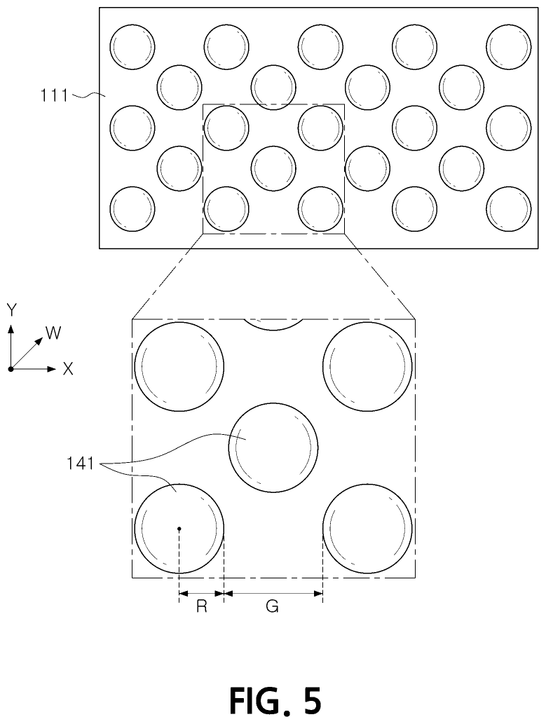

FIG. 5 schematically illustrates a plan view of a dielectric layer.

Hereinafter, a multilayer electronic component according to an embodiment of the present disclosure will be described in detail with reference to FIGS. 1 to 5. However, as an example of a multilayer electronic component, a multilayer ceramic capacitor is described, but the present disclosure may also be applied to various electronic products using a dielectric composition, such as inductors, piezoelectric elements, varistors, or thermistors.

A multilayer electronic component 100 according to an embodiment of the present disclosure may comprise: a body 110 including a dielectric layer 111 and internal electrodes 121 and 122 alternately disposed with the dielectric layer 111 in a first direction, first and second surfaces 1 and 2 opposing each other in the first direction, third and fourth surfaces 3 and 4 connected to the first and second surfaces 1 and 2 and opposing each other in a second direction, and fifth and sixth surfaces 5 and 6 connected to the first to fourth surfaces 1, 2, 3, and 4 and opposing each other in a third direction; and external electrodes 131 and 132 disposed on the body 110, wherein the dielectric layer 111 may include a plurality of first protrusions 141 having a hemispherical shape protruding only from one of the first and second surfaces 1 and 2, and may include a first opening portion, and at least a portion of the plurality of first protrusions 141 may be spaced apart from each other in the second direction, and when a radius of the first opening portion is R1 and a distance between an adjacent first protrusion 141 in the second direction is G1, R1 and G1 may satisfy 0.3 μm≤R1≤3.0 μm and 0.5×R1≤G1≤3.0×R1.

In addition, a multilayer electronic component 100 according to another embodiment of the present disclosure may comprise: the body 110 including the dielectric layer 111 and the internal electrodes 121 and 122 alternately disposed with the dielectric layer 111 in the first direction, the first and second surfaces 1 and 2 opposing each other in the first direction, the third and fourth surfaces 3 and 4 connected to the first and second surfaces 1 and 2 and opposing each other in the second direction, and the fifth and sixth surfaces 5 and 6 connected to the first to fourth surfaces 1, 2, 3, and 4 and opposing each other in the third direction; and the external electrodes 131 and 132 disposed on the body 110, wherein the internal electrode 121 and 122 may include a plurality of second protrusions 142 having a hemispherical shape protruding only from one of the first and second surfaces 1 and 2 and may include a second opening portion, and at least a portion of the plurality of second protrusions 142 may be spaced apart from each other in the second direction, when a radius of the second opening portion is R2 and a distance between the second protrusions 142 adjacent in the second direction is G3, R2 and G3 may satisfy 0.3 μm≤R2≤3.0 μm and 0.5×R2≤G3≤3.0×R2.

The body 110 may have a dielectric layer 111 and internal electrodes 121 and 122 alternately stacked.

More specifically, the body 110 may include a capacitance formation portion Ac forming capacitance, including a first internal electrode 121 and a second internal electrode 122 that are disposed alternately to oppose each other with a dielectric layer 111 interposed therebetween, the electrodes being disposed inside the body 110.

There is no particular limitation on the specific shape of the body 110, but as illustrated, the body 110 may have a hexahedral shape or a shape similar thereto. Due to shrinkage of the ceramic particles included in the body 110 during a sintering process, the body 110 may not have a hexahedral shape with entirely straight lines, but may have a substantially hexahedral shape.

The body 110 may have first and second surfaces 1 and 2 opposing each other in the thickness direction, third and fourth surfaces 3 and 4 connected to the first and second surfaces 1 and 2 and opposing each other in the length direction, and fifth and sixth surfaces 5 and 6 connected to the first to fourth surfaces 1, 2, 3, and 4 and opposing each other in the width direction.

A plurality of dielectric layers 111 forming the body 110 are in a sintered state, such that boundaries between adjacent dielectric layers 111 may be integrated so as to be difficult to identify without using a scanning electron microscope (SEM).

The raw material forming the dielectric layer 111 is not limited as long as sufficient electrostatic capacitance can be obtained. In general, perovskite ABO₃-based materials may be used, for example, barium titanate-based materials, lead composite perovskite-based materials, or strontium titanate-based materials may be used. The barium titanate-based material may include BaTiO₃-based ceramic particles, and examples of the ceramic particles include BaTiO₃, (Ba₁₋ₓCaₓ)TiO₃ (0<x<1), Ba(Ti_{1-y}Ca_{y})O₃ (0<y<1), (Ba₁₋ₓCaₓ)Ti_{1-y}Zr_{y})O₃ (0<x<1, 0<y<1) or Ba(Ti_{1-y}Zr_{y})O₃ (0<y<1), in which calcium Ca, zirconium Zr, or the like are partially dissolved.

In addition, the raw material for forming the dielectric layer 111 may be particles such as barium titanate BaTiO₃, to which various ceramic additives, organic solvents, binders, dispersants, or the like, may be added according to the purpose of the present disclosure.

Meanwhile, in order to distinguish a dielectric layer from the dielectric layers included in cover portions 112 and 113 and side margin portions 114 and 115 to be described later, the dielectric layer included in the capacitance forming portion Ac may be defined as a first dielectric layer, the dielectric layer included in the cover portions 112 and 113 may be defined as a second dielectric layer, and the dielectric layer included in the side margin portions 114 and 115 may be defined as a third dielectric layer.

In addition, since the first to third dielectric layers may be formed using a dielectric material such as barium titanate BaTiO₃, they may include a dielectric microstructure after sintering. The dielectric microstructure may include a plurality of grains, grain boundaries disposed between adjacent grains, and triple points disposed at points where three or more grain boundaries meet, and may each include a plurality of grains, grain boundaries, and triple points.

A thickness td of the dielectric layer 111 is not particularly limited.

In order to secure reliability of the multilayer electronic component 100 under a high-voltage environment, the thickness td of the dielectric layer 111 may be 10.0 μm or less, 9.0 μm or less, 8.0 μm or less, 7.0 μm or less, 6.0 μm or less, or 5.0 μm or less. In addition, in order to implement miniaturization and high capacitance of the multilayer electronic component 100, the thickness td of the dielectric layer 111 may be 3.0 μm or less. In order to more easily implement miniaturization and high capacitance, the thickness td of the dielectric layer 111 may be 1.0 μm or less, preferably 0.6 μm or less, 0.5 μm or less, and more preferably 0.4 μm or less.

Here, the thickness td of the dielectric layer 111 may mean the thickness td of the dielectric layer 111 disposed between the first and second internal electrodes 121 and 122.

In this case, the thickness td of the dielectric layer 111 may be a concept including the thickness td of any one of a plurality of dielectric layers 111, or may be a concept including the thickness td of each of all dielectric layers 111.

In addition, the thickness td of the dielectric layer 111 may mean the average thickness td of one dielectric layer 111, may mean an average thickness td of each of the plurality of dielectric layers 111, or may mean the average thickness td of the plurality of dielectric layers 111.

The average thickness td of the dielectric layer 111 may be measured by scanning an image of a cross-section in the length and thickness direction of the body 110 using a field emission scanning electron microscope (SEM) at 10,000× magnification. More specifically, the average thickness td of one dielectric layer 111 may mean an average value calculated by measuring the thickness of one dielectric layer 111 at 5 points equally spaced apart in the longitudinal direction in a scanned image. The 5 points equally spaced apart from each other may be designated in the capacitance formation portion Ac, and it may be desirable to measure at other points where the protrusions are not located. In addition, by extending this average value measurement to 3 dielectric layers 111 and calculate the average value, the average thickness td of the plurality of dielectric layers 111 may be further generalized.

Meanwhile, the dielectric layer 111 may include the plurality of first protrusions 141.

As the dielectric layer 111 may include the first protrusion 141, the internal electrodes 121 and 122 may include the second protrusions 142 described later, thereby increasing an overlapping area where the capacitance is formed to improve the capacitance characteristics.

The first protrusion 141 may protrude in only one of the first directions, for example, may protrude toward the first surface 1.

Since the first protrusion 141 protrudes only in one direction, alignment may be facilitated when stacking the dielectric layer 111 and the internal electrodes 121 and 122, and short circuits between adjacent internal electrodes 121 and 122 may be prevented.

The first protrusion 141 may have a hemispherical shape having a radius of R1 and a height of H1.

Here, the hemispherical shape may include a regular hemisphere with the same radius and height (R1=H1) and an irregular hemisphere having different radius and height (R1≠H1).

Also, the radius of a hemisphere may refer to a radius of a circle, taken on a cross-section of a sphere cut in half, and when a circle, which is a cross-section when a sphere is cut in half, is known as an opening, it may refer to a radius of the opening.

That is, the first protrusion 141 may be a hemispherical shape including a first opening portion having a radius R1 and a height H1, and may be at least one shape among a regular hemisphere having the same radius R1 and height H1 (R1=H1) and an irregular hemisphere having different radius R1 and height H1.

And, when a direction different from the second direction and the third direction is referred to as a fourth direction based on a plane surface including the second direction and the third direction, a plurality of first protrusions 141 may be spaced apart from each other in the second direction, the third direction, and the fourth direction. For example, a plurality of first protrusions 141 may be spaced apart by the same interval G in the second direction, spaced apart by the same interval G in the third direction, or spaced apart by the same interval G in the fourth direction, thereby having a regular pattern. In this case, it may be desirable for the intervals spaced apart in the second direction, the intervals spaced apart in the third direction, and the intervals spaced apart in the fourth direction to be spaced apart by the same interval G, but this is not limited, and they may be different from each other or only some intervals may be the same. For example, the fourth direction may also be referred to as the W-direction (or W-axis) illustrated in FIG. 5. A more specific example of a regular pattern of the plurality of first protrusions 141 may correspond to an embossing pattern.

Meanwhile, when a radius of the first opening portion is R1 and a distance between the first protrusion 141 adjacent in the second direction is G1, R1 and G1 may satisfy 0.3 μm≤R1≤3.0 μm and 0.5×R1≤G1≤3.0×R1.

Since R1 and G1 satisfy 0.3 μm≤R1≤3.0 μm and 0.5×R1≤G1≤3.0×R1, the capacitance characteristics may be excellent while the multilayer of the dielectric layer and internal electrodes can be facilitated. Here, excellent capacitance characteristics may mean that the capacitance characteristics are improved by more than 30% compared to conventional multilayer electronic components that do not include the first protrusion 141.

If R1 is less than 0.3 μm, it may be difficult to align the dielectric layer and internal electrodes, which may make manufacturing difficult or result in product defects, if R1 exceeds 3.0 μm, the gap between adjacent first protrusion 141 may become wider, which may not result in an excellent improvement in capacitance characteristics.

In addition, if G1 is less than 0.5×R1, it may be difficult to align the dielectric layer and internal electrodes, which may make manufacturing difficult or result in product defects, and if G1 exceeds 3.0×R1, the gap between adjacent first protrusion 141 may become wider, so the effect of improving capacitance characteristics may not be excellent.

Meanwhile, when the height of the first protrusion 141 is H1, it may satisfy 0.3 μm≤H1, and the upper limit value is not particularly limited, but may be ½ or less of the thickness td of the dielectric layer 111 (H1≤½×td), or may satisfy H1≤3.0 μm.

If H1 is less than 0.3 μm, there may be a concern that the capacitance characteristics may not be sufficiently improved, and if H1 is more than ½×td or more than 3.0 μm, there may be a concern that the internal electrodes 121 and 122 may be disconnected or a short may occur between adjacent internal electrodes 121 and 122.

In the present disclosure, the method for measuring a height H1 of the first protrusion 141, a radius R1 of the first opening portion, a distance G1 between the first protrusion 141 adjacent in the second direction, or a distance G2 between the second protrusion 142 adjacent in the third direction may be as follows, but is not particularly limited thereto.

The height H1 of the first protrusion 141 may be obtained by measuring the height difference between the first opening portion and the lowest surface of the internal electrode where the protrusion is formed when observing the first and second direction cross-sections of the body 110 using a scanning electron microscope (SEM). Other methods and/or tools appreciated by one of ordinary skill in the art, even if not described in the present disclosure, may also be used.

The radius R1 of the first opening portion may be obtained by multiplying the diameter of the first opening portion by ½ when observing the cross-section of the body 110 in the first and second directions using a scanning electron microscope (SEM), or by measuring from the center of the first opening portion to the end point of the first opening portion. Other methods and/or tools appreciated by one of ordinary skill in the art, even if not described in the present disclosure, may also be used.

The distance G1 between adjacent first protrusions 141 may be obtained by measuring the distance between one protrusion and another adjacent protrusion when observing the cross-sections of the body 110 in the first and second direction using a scanning electron microscope (SEM). And, in the same way, the distance G2 between adjacent first protrusions 141 in the third direction may be measured and obtained. Other methods and/or tools appreciated by one of ordinary skill in the art, even if not described in the present disclosure, may also be used.

In addition, when the distance between adjacent first protrusions 141 in the third direction is G2, R1 and G2 may satisfy 0.5×R1≤G2≤3.0×R1.

The content regarding the distance G2 between the radius R1 of the first opening portion and the first protrusion 141 adjacent in the third direction may overlap with the content regarding the distance G1 between the radius R1 of the first opening portion and the first protrusion 141 adjacent in the second direction, so it will be omitted, and it may be preferable that G1 and G2 are substantially the same.

And, the first protrusion 141 adjacent in the fourth direction may be disposed between the first protrusion 141 adjacent in the second direction and the first protrusion 141 adjacent in the third direction.

More specifically, what is meant by the first protrusion 141 being adjacent in the fourth direction is that it is spaced apart in the second direction by ½ of the distance G1 between the first protrusions 141 adjacent in the second direction from any one first protrusion 141, and that it is spaced apart in the third direction by ½ of the distance G2 between adjacent first protrusions 141 in the third direction from any one first protrusion 141, and referring to the drawings, this may mean that they are located in a diagonal direction, but is not particularly limited thereto.

The internal electrodes 121 and 122 may be alternately stacked with the dielectric layer 111.

The internal electrodes 121 and 122 may include a first internal electrode 121 and a second internal electrode 122, and the first and second internal electrodes 121 and 122 may be alternately disposed to face each other with the dielectric layer 111 constituting the body 110 interposed therebetween, and may be exposed to the third and fourth surfaces 3 and 4 of the body 110, respectively.

More specifically, the first internal electrode 121 may be spaced apart from the fourth surface 4 and exposed through the third surface 3, and the second internal electrode 122 may be spaced apart from the third surface 3 and exposed through the fourth surface 4.

A first external electrode 131 may be disposed on the third surface 3 of the body 110 and connected to the first internal electrode 121, and a second external electrode 132 may be disposed on the fourth surface 4 of the body 110 and connected to the second internal electrode 122.

That is, the first internal electrode 121 may be connected to the first external electrode 131 without being connected to the second external electrode 132, and the second internal electrode 122 may be connected to the second external electrode 132 without being connected to the first external electrode 131. At this time, the first and second internal electrodes 121 and 122 may be electrically separated from each other by a dielectric layer 111 disposed in the middle.

Meanwhile, a method for forming a dielectric layer 111 and/or the internal electrodes 121 and 122 including a hemispherical shape protruding may be as follows, but is not particularly limited thereto.

First, a first ceramic green sheet on which a paste for the first internal electrode is printed is prepared, and an object (e.g., a steel plate) having a protrusion formed such as an embossing pattern is pressed to form a hemispherical shape protruding toward the first surface 1. At this time, the first protrusion 141 may be formed on the first ceramic green sheet, and a second protrusion 142 may be formed on the printed paste for the first internal electrode. Afterwards, a second ceramic green sheet printed with paste for the second internal electrode is laminated, and an object having a protrusion such as an embossing pattern is pressed to form a hemispherical shape protruding toward the first surface 1. In this way, protrusions may be formed on a ceramic green sheet printed with paste for internal electrodes, and these may be alternately laminated and then fired to form a body 110 including the dielectric layer 111 and/or internal electrodes 121 and 122 on which first and second protrusions 141 and 142 are formed. Here, the paste for the internal electrode may become the internal electrodes 121 and 122 after firing, and the ceramic green sheet may become the dielectric layer 111 after firing.

The printing method of the conductive paste for the internal electrode may use a screen printing method or a gravure printing method, but the present disclosure is not limited thereto.

The material forming the internal electrodes 121 and 122 is not particularly limited, and a material with excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti) and alloys thereof.

Meanwhile, the thickness te of the internal electrodes 121 and 122 do not need to be particularly limited, and the description of the thickness te of the internal electrodes 121 and 122 below may mean the thickness te of each of the first internal electrode 121 and the second internal electrode 122.

In order to ensure reliability of the multilayer electronic component 100 under a high-voltage environment, the thickness te of the internal electrodes 121 and 122 may be 3.0 μm or less. Additionally, in order to achieve miniaturization and high capacitance of the multilayer electronic component 100, the thickness te of the internal electrodes 121 and 122 may be 1.0 μm or less. In order to more easily achieve miniaturization and high capacitance, the thickness te of the internal electrodes 121 and 122 may be 0.6 μm or less, 0.5 μm or less, and more preferably 0.4 μm or less.

At this time, the thickness te of the internal electrodes 121 and 122 may be a concept including the thickness te of at least one of the multiple internal electrodes 121 and 122, or may be a concept including the thickness te of all internal electrodes 121 and 122.

At this time, the thickness te of the internal electrodes 121 and 122 may be a concept including the thickness te of at least one of the plurality of internal electrodes 121 and 122, or may be a concept including the thickness te of all internal electrodes 121 and 122, respectively.

In addition, the thickness te of the internal electrodes 121 and 122 may mean an average thickness te of one internal electrodes 121 and 122, or may mean an average thickness te of each of the plurality of internal electrodes 121 and 122, or may mean an average thickness te of the plurality of internal electrodes 121 and 122.

The average thickness te of the internal electrodes 121 and 122 may be measured by scanning the cross-section of the body (110) in the length and thickness directions with a scanning electron microscope (SEM) at 10,000× magnification. More specifically, the average thickness te of one internal electrodes 121 and 122 may be an average value calculated by measuring the thickness of one internal electrode at 5 points equally spaced apart in the longitudinal direction in the scanned image. The 5 points equally spaced apart may be designated in the capacitance formation portion Ac, and it may be desirable to measure at other points where the protrusion is not located. In addition, extending this average value measurement to 3 internal electrodes 121 and 122, and measuring the average value, the average thickness te of the plurality of internal electrodes 121 and 122 may be further generalized.

Meanwhile, the internal electrodes 121 and 122 may include a plurality of second protrusion 142, and the second protrusion 142 may be the same as the description for the first protrusion 141. In other words, if the first protrusion 141 and the second protrusion 142 have a desirable structure, they may be interpreted as one protrusion, but are not particularly limited thereto.

As the internal electrodes 121 and 122 include the second protrusion 142, the overlapping area where the capacitance is formed is increased, thereby improving the capacitance characteristics.

The second protrusion 142 may protrude in only one of the first directions, for example, may protrude toward the first surface 1.

Since the second protrusion 142 protrudes in only one direction, alignment may be facilitated when stacking the dielectric layer 111 and the internal electrodes 121 and 122, and short circuits between adjacent internal electrodes 121 and 122 may be prevented.

The second protrusion 142 may have a hemispherical shape having a radius of R2 and a height of H2.

Here, the hemispherical shape may include a regular hemisphere with the same radius and height (R2=H2) and an irregular hemisphere with different radius and height (R2≠2).

That is, the second protrusion 142 may be a hemispherical shape including a second opening portion having a radius R2 and a height H2, and may be at least one shape among a regular hemisphere having the same radius R2 and height H2 (R2=H2) and an irregular hemisphere having different radius R2 and height H2.

And, the plurality of second protrusion 142 may be spaced apart from each other in the second direction, the third direction, and the fourth direction, and the second to fourth directions may be the same as those described for the first protrusion 141. In a more specific example, a plurality of second protrusions 142 may be spaced apart by the same interval G in the second direction, spaced apart by the same interval G in the third direction, or spaced apart by the same interval G in the fourth direction, thereby having a regular pattern. At this time, it may be desirable that the intervals spaced apart in the second direction, the intervals spaced apart in the third direction, and the intervals spaced apart in the fourth direction to be spaced apart by the same interval G, but this is not limited to this, and the intervals may be different from each other, or only some intervals may be the same. More specifically, for example, the regular pattern of multiple second protrusion 142 may correspond to an embossing pattern.

Meanwhile, when a radius of the second opening portion is R2 and a distance between the second protrusion 142 adjacent in the second direction is G2, R2 and G2 may satisfy 0.3 μm≤R2≤3.0 μm and 0.5×R2≤G2≤3.0×R2.

Since R2 and G2 satisfy 0.3 μm≤R2≤3.0 μm and 0.5×R2≤G2≤3.0×R2, the capacitance characteristics may be excellent while the lamination of the dielectric layer and internal electrodes can be facilitating. Here, excellent capacitance characteristics may mean that the capacitance characteristics are improved by more than 30% compared to conventional multilayer electronic components that do not include the second protrusion 142.

If R2 is less than 0.3 μm, it may be difficult to align the dielectric layer and internal electrodes, which may make manufacturing difficult or result in product defects, and if R2 exceeds 3.0 μm, the gap between adjacent second protrusions 142 may become wider, which may result in poor capacitance characteristic improvement.

In addition, if G2 is less than 0.5×R2, it is difficult to align the dielectric layer and internal electrodes, which may make manufacturing difficult or result in product defects, and if G2 exceeds 3.0×R2, the gap between adjacent second protrusions 142 may become wider, which may not result in an excellent capacitance characteristic improvement effect.

Meanwhile, when the height of the second protrusion 142 is H2, it may satisfy 0.3 μm≤H2, and the upper limit value is not particularly limited, but may be less than or equal to ½ of the thickness td of the dielectric layer 111 (H2≤½×td), or may satisfy H2≤3.0 μm.

If H1 is less than 0.3 μm, there is a concern that the capacitance characteristics may not be sufficiently improved, and if H2 is greater than ½×td or greater than 3.0 μm, there is a concern that the internal electrodes 121 and 122 may be disconnected or a short circuit may occur between adjacent internal electrodes 121 and 122.

In the present disclosure, the method of measuring the height H2 of the second protrusion 142, the radius R2 of the second opening portion, the distance G3 between the second protrusion 142 adjacent in the second direction, or the distance G4 between the second protrusion 142 adjacent in the third direction is the same as that of the first protrusion 141 described above, and thus will be omitted.

And, the second protrusion 142 adjacent in the fourth direction may be disposed between the second protrusion 142 adjacent in the second direction and the second protrusion 142 adjacent in the third direction.

More specifically, the meaning of the second protrusion 142 being adjacent in the fourth direction may mean that they are disposed at a distance in the second direction equal to ½ the distance G2 between adjacent second protrusion 142 in the second direction from any one second protrusion 142, and at a distance in the third direction equal to ½ the distance G2 between adjacent second protrusion 142 in the third direction from any one second protrusion 142, and referring to the drawing, it may mean that it is located in a diagonal direction, but it is not particularly limited to this.

[Table 1] below illustrates the capacitance characteristics in percentage according to a radius R of the opening portion (where 0.3 μm≤R≤3.0 μm) and a distance G between adjacent protrusions, and calculates and describes the expected capacitance characteristic improvement value assuming that the protrusions are regular hemispheres (R=H). And, the capacitance characteristics of the multilayer electronic component without the conventional protrusions were calculated by setting the reference value (100%).

TABLE 1

| | | Capacitance |
|---|---|---|
| R | G | characteristics |
| Non-formation | Non-formation | 100% |
| of protrusion | of protrusion | |
| R | <0.5 × R | — |
| R | 0.5 × R | 163% |
| R | 1.0 × R | 152% |
| R | 1.5 × R | 145% |
| R | 2.0 × R | 139% |
| R | 2.5 × R | 135% |
| R | 3.0 × R | 131% |
| R | 3.5 × R | 129% |

Even if protrusions are formed, if the spacing between protrusions G is less than 0.5×R, it may be expected that alignment of the dielectric layer and internal electrodes will be difficult and lamination will not be possible.

When the spacing between protrusions G is 0.5×R to 3.0×R, the capacitance characteristics are expected to increase by more than 31% compared to conventional multilayer electronic components without protrusions.

When the spacing between protrusions G is 3.5×R, the capacitance characteristics are expected to increase by more than 29% compared to conventional multilayer electronic components without protrusions, but this is a figure falling short of the capacitance characteristic improvement that the present disclosure seeks to achieve.

The thickness td of at least one of the plurality of dielectric layers 111 and the thickness te of at least one of the plurality of internal electrodes 121 and 122 may satisfy 2×te<td.

In other words, the thickness td of one dielectric layer 111 may be greater than twice the thickness te of one internal electrodes 121 and 122. Preferably, the average thickness td of the plurality of dielectric layer 111 may be greater than twice the average thickness te of the plurality of internal electrodes 121 and 122.

In general, a reliability issue due to a decrease in the breakdown voltage (BDV) under a high-voltage environment may be a major issue for high-voltage electronic components.

Accordingly, in order to prevent a decrease in the breakdown voltage under a high-voltage environment, the breakdown voltage characteristics may be improved by configuring the average thickness td of the dielectric layer 111 greater than twice the average thickness te of the internal electrodes 121 and 122.

When the average thickness td of the dielectric layer 111 is less than twice the average thickness te of the internal electrodes 121 and 122, the breakdown voltage may decrease and a short may occur between the internal electrodes.

Meanwhile, the body 110 may include cover portions 112 and 113 disposed on both end-surfaces of the capacitance formation portion Ac in the thickness direction.

Specifically, the body 110 may include a first cover portion 112 disposed on one surface of the capacitance formation portion Ac in the thickness direction and a second cover portion 113 disposed on the other surface of the capacitance formation portion Ac in the thickness direction. More specifically, for example, the body 110 may include the first cover portion 112 disposed on a lower portion of the capacitance formation portion Ac in the thickness direction and a second cover portion 113 disposed on an upper portion of the capacitance formation portion Ac in the thickness direction.

The first cover portion 112 and the second cover portion 113 may be formed by disposing or stacking a single second dielectric layer or two or more second dielectric layers on the upper and lower surfaces of the capacitance formation portion Ac in the thickness direction, respectively, and may prevent damage to the internal electrodes 121 and 122 due to physical or chemical stress.

The first cover portion 112 and the second cover portion 113 may not include internal electrodes 121 and 122 and may include the same dielectric material as the first dielectric layer 111 of the capacitance formation portion Ac. That is, the first cover portion 112 and the second cover portion 113 may include a dielectric material, for example, a barium titanate (BaTiO₃)-based dielectric material.

Meanwhile, the thickness tc of the cover portions 112 and 113 may not need to be particularly limited, and a description of the thickness tc of the cover portions 112 and 113 may mean the thickness tc of each of the first cover portion 112 and the second cover portion 113.

However, in order to easily implement miniaturization and high capacitance of the multilayer electronic component 100, the thickness tc of the cover portions 112 and 113 may be 100 μm or less or 50 μm or less, preferably 30 μm or less, and more preferably 20 μm or less in ultra-small products.

Here, the thickness tc of the cover portions 112 and 113 may mean the average thickness of the cover portions 112 and 113.

Additionally, the average thickness tc of the cover portions 112 and 113 may mean the average thickness tc of each of the first and second cover portions 112 and 113, or may mean the average thickness tc of the first and second cover portions 112 and 113.

The average thickness tc of the cover portions 112 and 113 may be measured by scanning an image of a cross-section of the body 110 in the length and thickness direction using a scanning electron microscope (SEM) at 10,000× magnification. More specifically, it may mean an average value calculated by measuring the thickness at 5 points equally spaced apart in the longitudinal direction in an image scanned of one cover portions 112 and 113.

In addition, the average thickness tc of the cover portions 112 and 113 measured by the above-described method may have a value substantially the same as the average thickness of the cover portions 112 and 113 in the cross-section of the body 110 in the width and thickness direction.

Meanwhile, the multilayer electronic component 100 may include a side margin portions 114 and 115, which is a width-wise end region of the internal electrodes 121 and 122.

More specifically, the side margin portions 114 and 115 may include a first side margin portion 114 disposed between the internal electrodes 121 and 122 and the fifth surface 5 and a second side margin portion 115 disposed between the internal electrodes 121 and 122 and the sixth surface 6.

As illustrated, the side margin portions 114 and 115 may refer to a region between the width-wise ends of the first and second internal electrodes 121 and 122 and the boundary surface of the body 110, based on the cross-section of the body 110 in the width and thickness directions.

The side margin portions 114 and 115 may refer to a ceramic green sheet region excluding the internal electrodes 121 and 122 when the internal electrode paste is applied onto the ceramic green sheet for the capacitance formation portion Ac, excluding regions corresponding to the side margin portions 114 and 115.

However, it is not particularly limited thereto, and the side margin portions 114 and 115 may be formed by applying a conductive paste to the ceramic green sheet applied to the capacitance formation portion Ac, other than the region in which the side margin portions 114 and 115 may be formed, thereby forming internal electrodes 121 and 122, and in order to suppress a step difference caused by the internal electrodes 121 and 122, the body 110 may be cut so that the internal electrodes 121 and 122 after stacking to be exposed to the fifth and sixth surfaces 5 and 6 of the body 110, and then a single third dielectric layer or two or more third dielectric layers may be formed by disposing or stacking them on both end-surfaces of the capacitance formation portion Ac in the width direction.

The side margin portions 114 and 115 may basically contribute to prevent damage to the internal electrodes 121 and 122 due to physical or chemical stress.

The side margin portions 114 and 115 may not include the internal electrodes 121 and 122, and may include the same material as the first dielectric layer 111. That is, the first side margin portion 114 and the second side margin portion 115 may include a dielectric material, for example, a barium titanate (BaTiO₃)-based dielectric material.

Meanwhile, a width wm of the side margin portions 114 and 115 may not need to be particularly limited, and the description of the width wm of the side margin portions 114 and 115 may mean a width wm of the first side margin portion 114 and the second side margin portion 115, respectively.

In order to easily implement miniaturization and high capacitance of the multilayer electronic component 100, the width wm of the side margin portions 114 and 115 may be 50 μm or less, preferably 30 μm or less, and may be more preferably 20 μm or less in ultra-small products.

Here, the width wm of the side margin portions 114 and 115 may mean an average width wm of the side margin portions 114 and 115.

Additionally, the average width wm of the side margin portions 114 and 115 may mean the average width wm of each of the first and second side margin portions 114 and 115, or may mean an average width wm of the first and second side margin portions 114, 115.

The average width wm of the side margin portions 114 and 115 may be measured by scanning an image of a cross-section of the body 110 in the width and thickness direction using a scanning electron microscope (SEM) at 10,000× magnification. More specifically, it may mean an average value calculated by measuring the width at 5 points equally spaced apart in the thickness direction in an image scanned of one side margin portions 114 and 115.

In an embodiment of the present disclosure, a structure in which the multilayer electronic component 100 may have two external electrodes 131 and 132 is described, but the number or shape of the external electrodes 131 and 132 may be varied depending on the form of the internal electrodes 121 and 122 or other purposes.

The external electrodes 131 and 132 may be disposed on the body 110 and may be connected to the internal electrodes 121 and 122.

More specifically, the external electrodes 131 and 132 may be disposed on the third and fourth surfaces 3 and 4 of the body 110, respectively, and may include first and second external electrodes 131 and 132 connected to the first and second internal electrodes 121 and 122, respectively. That is, the first external electrode 131 may be disposed on the third surface 3 of the body and may be connected to the first internal electrode 121, and the second external electrode 132 may be disposed on the fourth surface 4 of the body and may be connected to the second internal electrode 122.

Additionally, the external electrodes 131 and 132 may extend and be disposed on portions of the first and second surfaces 1 and 2 of the body 110, or may extend and be disposed on portions of the fifth and sixth surfaces 5 and 6 of the body 110. That is, the first external electrode 131 may be disposed on the third surface 3 of the body 110 and a portion of the first, second, fifth, and sixth surfaces 1, 2, 5, and 6 of the body 110, and the second external electrode 132 may be disposed on the fourth surface 4 of the body 110 and a portion of the first, second, fifth, and sixth surfaces 1, 2, 5, and 6 of the body 110.

The external electrodes 131 and 132 may be formed of any material having electrical conductivity, such as metal, and a specific material may be determined in consideration of electrical characteristics and structural stability, or the like, and may include an electrode layer. Furthermore, the electrode layer may have a multilayer structure.

For example, the external electrodes 131 and 132 may include a first electrode layers 131a and 131b disposed on the body 110, and a second electrode layers 131b and 132b disposed on the first electrode layers 131a and 132a. Furthermore, it may include a third electrode layer disposed between the first electrode layers 131a and 132a, and the second electrode layers 131b and 132b.

Here, it may be desirable for the first to third electrode layers to correspond to distinct layers. However, it is not particularly limited to this, and may be distinguished according to the order of the manufacturing process, and at least some of the layers among the first to third electrode layers may not be distinguished from each other and may be observed as one layer.

In the present disclosure, the term “distinguished” may mean that two layers are distinguished due to physical differences, chemical differences, and/or simple optical differences, and is not particularly limited thereto, but the distinction between layers may be identified by the presence or absence of an “interface.” The term “interface” may mean a surface where two layers in contact with each other are distinguishable from each other, and may mean a state where they can be distinguished by differences in components, such as through EDS analysis using equipment such as a scanning electron microscope (SEM).

The first electrode layers 131a and 132a, and/or the third electrode layer may be formed by transferring a sheet including a conductive metal onto the body 110, or may be formed by applying a conductive paste for an external electrode including a conductive metal to the body 110 and then performing sintering, or may be formed by dipping the body 110 into a conductive paste for an external electrode including a conductive metal, but is not particularly limited thereto.

More specifically, the first electrode layers 131a and 132a may be disposed to be in direct contact with the body 110 and may include a first conductive metal and glass, and the third electrode layer may be disposed on the first electrode layers 131a and 132a, and may include a second conductive metal and resin.

A material having excellent electrical conductivity may be used as the conductive metal included in the first electrode layers 131a and 132a, and the third electrode layer, and for example, the conductive metal may include one or more selected from a group consisting of nickel (Ni), copper (Cu), palladium (Pd), silver (Ag), gold (Au), platinum (Pt), tin (Sn), tungsten (W), titanium (Ti) and alloys thereof, but is not particularly limited thereto.

Here, the conductive metal included in the first electrode layers 131a and 132a, may be referred to as the first conductive metal, and the conductive metal included in the third electrode layer may be referred to as the second conductive metal. In this case, the first conductive metal and the second conductive metal may be the same or different from each other, and when a plurality of conductive metals are included, only a portion of them may include the same conductive metal, but this is not particularly limited thereto.

The glass included in the first electrode layers 131a and 132a may improve bonding with the body 110, and is not particularly limited as long as it may improve bonding with the body 110. The resin included in the third electrode layer may contribute to improve flexural strength, and is not particularly limited as long as it can be mixed with the second conductive metal to form a paste, and may include, for example, an epoxy resin.

The first conductive metal included in the first electrode layers 131a and 132a may be configured to electrically connect with the internal electrodes 121 and 122.

The first conductive metal included in the first electrode layers 131a and 132a is not particularly limited as long as it is a material that can be electrically connected to the internal electrodes 121 and 122, and may include, for example, at least one of nickel (Ni), copper (Cu), palladium (Pd), silver (Ag), gold (Au), platinum (Pt), tin (Sn), tungsten (W), titanium (Ti), and alloys thereof.

The second conductive metal included in the third electrode layer may be configured to electrically connect with the first electrode layers 131a and 132a.

The second conductive metal included in the third electrode layer is not particularly limited as long as it is a material that can be electrically connected to the first electrode layers 131a and 132a, and may include at least one of nickel (Ni), copper (Cu), palladium (Pd), silver (Ag), gold (Au), platinum (Pt), tin (Sn), tungsten (W), titanium (Ti), and alloys thereof.

The second conductive metal included in the third electrode layer may include at least one of spherical particles and flake-shaped particles. That is, the second conductive metal may be composed solely of flake-shaped particles, solely of spherical particles, or may be a mixture of flake-shaped particles and spherical particles.

Here, the spherical particles may also include shapes that are not perfectly spherical, for example, shapes having a dimensional ratio in the major axis to minor axis direction (major axis/minor axis) of 1.45 or less. Flake-shaped particles refer to particles having a flat and elongated shape, and are not particularly limited, but for example, the dimensional ratio in the long axis and short axis directions (long axis/short axis) may be 1.95 or more. The dimensions of the spherical particles and flake-shaped particles in the major and minor axis directions may be measured from images obtained by scanning a cross-section in the length and thickness directions cut from the center of the width direction of the multilayer electronic component using a scanning electron microscope (SEM).

Additionally, the third electrode layer may include an intermetallic compound.

By including an intermetallic compound, electrical connectivity with the first electrode layers 131a and 132a may be further improved. The intermetallic compound configures to improve electrical connectivity by connecting a plurality of second conductive metal particles, and may configure to surround and connect the plurality of second conductive metal particles to each other.

At this time, the intermetallic compound may include a metal having a melting point lower than the curing temperature of the resin. That is, because the intermetallic compound contains a metal with a melting point lower than the curing temperature of the resin, the metal having a melting point lower than the curing temperature of the resin melts during the drying and curing process, forms an intermetallic compound with a portion of the metal particles, and surrounds the metal particles. At this time, the intermetallic compound may preferably include a low melting point metal of 300° C. or less. More specifically, it may include tin (Sn) having a melting point of 213 to 220° C. During the drying and hardening process, tin (Sn) is melted, and the molten tin (Sn) wets high-melting-point metal particles such as silver (Ag), nickel (Ni), or copper (Cu) by capillary action, and may react with a portion of the silver (Ag), nickel (Ni), or copper (Cu) metal particles to form intermetallic compounds such as Ag₃Sn, Ni₃Sn₄, Cu₆Sn₅, and Cu₃Sn. Silver (Ag), nickel (Ni), or copper (Cu) that did not participate in the reaction may remain in the form of metal particles.

Accordingly, the plurality of second conductive metal particles may include at least one of silver (Ag), nickel (Ni), and copper (Cu), and the intermetallic compound may include one or more of Ag₃Sn, Ni₃Sn₄, Cu₆Sn₅, and Cu₃Sn.

The second electrode layers 131b and 132b may contribute to improve the mounting characteristics, and may be a plating layer formed on the first electrode layers 131a and 132a, or the third electrode layer by plating, but are not particularly limited thereto.

The type of the second electrode layers 131b and 132b is not particularly limited, and may include, for example, at least one of nickel (Ni), tin (Sn), silver (Ag), palladium (Pd), and alloys thereof.

The second electrode layers 131b and 132b may be a single layer or may be multiple layers.

More specifically, for example, the second electrode layers 131b and 132b may be a nickel (Ni) electrode layer or a tin (Sn) electrode layer, and may be in the form of a nickel (Ni) electrode layer and a tin (Sn) electrode layer sequentially formed on the first electrode layers 131a and 132a or the third electrode layer, or may be in the form of a tin (Sn) electrode layer, a nickel (Ni) electrode layer, and a tin (Sn) electrode layer sequentially formed. Additionally, the second electrode layers 131b and 132b may include a plurality of nickel (Ni) electrode layers and/or a plurality of tin (Sn) electrode layers.

There is no need to specifically limit the size of the multilayer electronic component 100.

However, in order to achieve miniaturization and high capacitance at the same time, the effect of the present disclosure may be more noticeable in a multilayer electronic component 100 having a size of 3216 (length×width: 3.2 mm×1.6 mm, length and width satisfy an error of 10%) or less. Additionally, the multilayer electronic component 100 may have a width greater than a length.

Although the embodiments of the present disclosure have been described in detail above, the present disclosure is not limited by the above-described embodiments and the accompanying drawings, and is intended to be limited by the appended claims. Therefore, various forms of substitution, modification, and change will be possible by those skilled in the art within the scope of the technical spirit of the present disclosure described in the claims, which also falls within the scope of the present disclosure.

In addition, the expression ‘one embodiment’ used in the present disclosure does not mean the same embodiment, and is provided to emphasize and describe different unique characteristics. However, one embodiment presented above is not excluded from being implemented in combination with features of another embodiment. For example, even if a matter described in one specific embodiment is not described in another embodiment, it can be understood as a description related to another embodiment, unless there is a description contradicting or contradicting the matter in the other embodiment.

Terms used in this disclosure are only used to describe one embodiment, and are not intended to limit the disclosure. In this case, singular expressions include plural expressions unless the context clearly indicates otherwise.

While the embodiments have been illustrated and described above, it will be configured as apparent to those skilled in the art that modifications and variations could be made without departing from the scope of the present disclosure as defined by the appended claims.

What is claimed is:

1. A multilayer electronic component comprising:
a body including a dielectric layer and internal electrodes alternately disposed with the dielectric layer in a first direction, the body including first and second surfaces opposing each other in the first direction, third and fourth surfaces connected to the first and second surfaces and opposing each other in a second direction, and fifth and sixth surfaces connected to the first to fourth surfaces and opposing each other in a third direction; and
an external electrode disposed on the body;
wherein the dielectric layer includes:
a plurality of first protrusions having a hemispherical shape protruding only from either the first surface or the second surface, where at least a portion of the plurality of first protrusions are spaced apart from each other in the second direction; and
a first opening portion,
when a radius of the first opening portion is R1 and, in the second direction, a distance between adjacent first protrusions among the plurality of first protrusions is G1, R1 and G1 satisfy 0.3 μm≤R1≤3.0 μm and 0.5×R1≤G1≤3.0×R1.

2. The multilayer electronic component of claim 1, wherein the plurality of first protrusions protrude toward the first surface.

3. The multilayer electronic component of claim 1, wherein the plurality of first protrusions are embossing patterns.

4. The multilayer electronic component of claim 1, wherein 0.3 μm≤H1 is satisfied, where a height of the first protrusion is H1.

5. The multilayer electronic component of claim 1, wherein a direction different from the second and third directions is referred to as a fourth direction, based on a plane surface including the second and third directions, and
wherein the plurality of first protrusions are spaced apart from each other in the second direction, the third direction, and the fourth direction.

6. The multilayer electronic component of claim 5, wherein, in the third direction, a distance between adjacent first protrusions among the plurality of first protrusions is G2, and
wherein the R1 and G2 satisfy 0.5×R1≤G2≤3.0×R1.

7. A multilayer electronic component, comprising:
a body including a dielectric layer and internal electrodes alternately disposed with the dielectric layer in a first direction, the body including first and second surfaces opposing each other in the first direction, third and fourth surfaces connected to the first and second surfaces and opposing each other in a second direction, and fifth and sixth surfaces connected to the first to fourth surfaces and opposing each other in a third direction; and
an external electrode disposed on the body;
wherein the internal electrodes include a plurality of second protrusions having a hemispherical shape protruding only from either the first surface or the second surface, where at least a portion of the plurality of second protrusions are spaced apart from each other in the second direction; and
a second opening portion,
when a radius of the second opening portion is R2 and, in the second direction, a distance between adjacent second protrusions among the plurality of second protrusions is G3, R2 and G3 satisfy 0.3 μm≤R2≤3.0 μm and 0.5×R2≤G3≤3.0×R2.

8. The multilayer electronic component of claim 7, wherein the plurality of second protrusions protrude toward the first surface.

9. The multilayer electronic component of claim 7, wherein the plurality of second protrusions are embossing patterns.

10. The multilayer electronic component of claim 7, wherein 0.3 μm≤H2 is satisfied, when a height of the second protrusion is H2.

11. The multilayer electronic component of claim 7, wherein, when a direction different from the second and third directions is referred to as a fourth direction based on a plane surface including the second and third directions, and
wherein the plurality of second protrusions are spaced apart from each other in the second direction, the third direction, and the fourth direction.

12. The multilayer electronic component of claim 11, wherein, in the third direction, a distance between adjacent second protrusions among the plurality of second protrusions is G4, and
wherein the R2 and G4 satisfy 0.5×R2≤G4≤3.0×R2.

13. A method of manufacturing the multilayer electronic component of claim 1, comprising:
pressing an object having a protrusion onto a first ceramic green sheet, wherein a paste that forms the internal electrodes is disposed on the first ceramic green sheet, and wherein the protrusion contacts the first ceramic green sheet,
laminating a second ceramic green sheet on the first ceramic green sheet, wherein the paste is disposed on the second ceramic green sheet, and
pressing the object onto the second ceramic green sheet.

14. The method of claim 13, wherein the protrusion is an embossing pattern.
